(19) United States
(12) Patent Application Publication
(10) Pub. No.: US 2020/0355002 A1
(43) Pub. Date: Nov. 12, 2020

(54) DOOR, DOOR CLOSING ARRANGEMENT AND DOOR ASSEMBLY

(71) Applicant: Torsten KOHL, Belmont (AU)

(72) Inventors: Torsten KOHL, Belmont (AU); Gerhard KOHL, Belmont (AU)

(21) Appl. No.: 16/942,043

(22) Filed: Jul. 29, 2020

Related U.S. Application Data
(63) Continuation of application No. PCT/AU2019/050065, filed on Jan. 30, 2019.

(30) Foreign Application Priority Data
Jan. 31, 2018 (AU) 2018900301

(51) Int. Cl. E05D 15/54; E06B 7/36; E05B 65/06; E06B 3/36; E05D 3/08

(52) U.S. Cl. CPC E05D 15/54; E06B 7/362; E05B 65/06; E05Y 2900/132; E05D 3/08; E06B 2007/365; E06B 3/36

(57) ABSTRACT

A door is provided for restricting access through a doorway aperture. The door is defined at one or more peripheral faces, and is movable between a closed position in which the door is substantially aligned with the doorway aperture and an open position in which the door is pivoted from alignment with the doorway aperture to either side of the doorway aperture. The door has a door member defining a pair of major faces and at least one minor face at a peripheral edge of the major faces where a cross-section of at least one of the minor faces of the door member is configured to be substantially curved, so that in operation when the door is moved between its open position and closed position from either side of the doorway aperture, the minor faces remain proximate to at least one peripheral face of the doorway aperture.

### CROSS REFERENCE TO RELATED APPLICATIONS

This application is a continuation of International Application PCT/AU2019/050065, filed Jan. 30, 2019, which claims priority to Australian Patent Application No. 2018900301, filed Jan. 31, 2018, the contents of each of which are incorporated by reference herein.

### FIELD OF THE INVENTION

The present invention relates to a door, door closing arrangement and door assembly.

### BACKGROUND OF THE INVENTION

A typical door arrangement consists of a doorway aperture or door frame which defines an opening in a wall, a door jamb disposed along an inner periphery of the door frame, and a door which is hingedly mounted to the door jamb so as to allow it to swing relative to the door jamb to one side of the door frame.

When a conventional door is swung into a closed position relative to the door frame, an edge of the door will generally abut flush against the door jamb such that the door jamb impedes further movement of the door past the door frame to the other side of the door frame. Thus, swinging movement of the door is effectively confined to one side of the door frame by the presence of the door jamb.

Conventional butt hinges [with inserted pins] also open in one direction only, thereby preventing movement of the door past the door frame to the other side of the doorway aperture, limiting swinging movement of the door to just one side of the door frame.

In certain situations, problems may arise with conventional door arrangements.

For instance, if a person in a bathroom were slumped injured or unconscious against the back of the door, and the door is ordinarily opened by swinging it inwardly into the bathroom, it may be extremely difficult, or even impossible to push the door open in order to administer urgent medical attention to the immobile person due to the person's mass now blocking the door. It may also not be possible to pull a conventional door open outwardly of the bathroom due to the protruding door jamb and the butt hinges.

Conventional door arrangements may also exhibit other deficiencies in their operation.

One such problem occurs when a door is opened and a gap develops between a conventional door and the door jamb at the hinge side edge periphery of the door. A person, and especially a child, may place their fingers into this gap, and the closing of the door can potentially crush, injure, or amputate the person's, or the child's fingers. This may especially be the case where automatic closing systems such as pneumatic door closers are used. Moreover, unrestrained doors that are open can be blown shut by the wind, or slammed shut by boisterous child's play, possibly causing injury as described above.

Automatic door closing mechanisms such as pneumatic door closers, and others, typically act to bias the door in a single direction only.

Another common problem occurs when a conventional door opens outwardly of a room into a hallway or other high traffic area. This may be necessary to facilitate swift and easy retreat from a room. Having such a conventional door open outwardly overcomes the problem of persons being confined behind a door, but creates a new problem because the door now becomes a safety hazard to users of the hallway or high traffic zone when the door is left open after use.

Another shortcoming of a conventional door may occur when a pneumatic closer becomes a prerequisite to close the door. Certain doors are meant to be kept closed when not in use. One reason may be to avoid heat loss or heat gain to air conditioned environs; another may be to maintain protection from pests and insects.

Yet a further problem with a conventional door is that cold draughts are able to enter a room via the space between the floor and the door, and the door jamb and door edge periphery when the door is in a closed position. In other cases, where the door is used as a bathroom or toilet door, bad smells may emanate out of the room via the air space between the floor, the door, and the door jamb when the door is closed. Often, the occupants will attempt to plug the space under the door by positioning a draught excluder (a snake-like cloth bag typically filled with sand or cotton stuffing) at the base of the door to prevent cold or smelly air from passing through. However, such an approach is deficient in effectively addressing the problem in that it tends to block only a limited section of the air space; that is, the space between a bottom edge of the door and the floor.

Also, such measures may be inconvenient in that generally the door snake has to be moved whenever the door is opened. Moreover, makeshift draught excluders or “door snakes” are often poorly suited to block the air due to materials used, and are typically considered to be a trip hazard.

There are also problems associated with certain prior art windows which tend to swing only in an outward direction from the building. For instance, the outward facing surface of a window pane on the prior art window is generally not easily accessible for cleaning from within a building as a person situated within the building must precariously lean out of the window in order to reach the entire outward-facing surface of the window pane to properly effect cleaning. This is particularly dangerous where the window is located on the higher levels of a high-rise building as it is hazardous for a cleaner to extend any part of their body out of the window since there is an increased risk that the person may inadvertently fall out.

It is to be understood that if any prior art information is referred to herein, such reference does not constitute an admission that the information forms part of the common general knowledge in the art, in Australia or any other country.

It is an object of the present invention to provide a door arrangement which overcomes or at least partially ameliorates some of the abovementioned disadvantages or which at least provides the public with a useful choice.

### SUMMARY OF THE INVENTION

According to a first aspect, there is provided a door for restricting access through a doorway aperture defining at least one or more peripheral faces, the door being movable between a closed position in which the door is substantially aligned with the doorway aperture and an open position in which the door is pivoted from alignment with the doorway aperture to either side of the doorway aperture, the door comprising:
a. a door member defining a pair of major faces and at least one or more minor faces at a peripheral edge of the major faces;
b. wherein a cross-section of at least one of the minor faces of the door member is configured to be substantially curved, so that in operation when the door is moved between its open position on either side of the doorway aperture and its closed position, the minor face remains proximate to at least one peripheral face of the doorway aperture.

In one embodiment, the cross-section of the at least one minor face is substantially semicircular.

In one embodiment, the door comprises a pivoting arrangement on which the door is pivotable between its open position and its closed position.

In one embodiment, the door member defines an upper minor face and a lower minor face, and the pivoting arrangement is configured to be received within one or more selected from apertures and recesses in the upper minor face and the lower minor face.

In one embodiment, the door comprises a latching arrangement.

In one embodiment, the latching arrangement comprises a latch member.

In one embodiment, the latch member is configured for engaging with a latch plate from both sides of the doorway aperture in operation.

In one embodiment, when the door member is in its closed position in operation, the latch member is configured for being received into one or more selected from an adjustable aperture and a recess in the latch plate.

In one embodiment, the latch member is configured to be moved between
a. a movable condition in which the latch member is movable to allow movement of the door member between its open position and its closed position; and
b. a locked condition in which the latch member is locked in position to prevent movement of the door member from its closed position to its open position.

In one embodiment, the door comprises an airflow restricting assembly.

In one embodiment, the airflow restricting assembly comprises a rigid insert.

In one embodiment, the rigid insert is configured to be receivable within recesses disposed around the peripheral minor faces of the door member.

In one embodiment, the recesses are integrally formed into the minor faces of the door member.

In one embodiment, the recesses are detachable from the minor faces of the door member.

In one embodiment, the rigid insert is configured to be receivable within recesses disposed around the peripheral faces of the doorway aperture.

In one embodiment, the recesses are integrally formed into the peripheral faces of the doorway aperture.

In one embodiment, the recesses are detachable from the peripheral faces of the doorway aperture.

In one embodiment, the rigid insert is configured to complement the shape of the recess.

In one embodiment, the rigid insert is configured to comprise a restrictor arrangement.

In one embodiment, the thickness of the restrictor arrangement is adjustable.

In one embodiment, when the door member is in its closed position in operation, the airflow restricting assembly extends into a gap between the minor faces of the door member and the doorway aperture.

In one embodiment, when the rigid insert is received into the recesses, the restrictor arrangements are configured to extend into the gap between the minor faces of the door member and the doorway aperture when the door member is in its closed position, to thereby prevent or restrict airflow through that gap.

According to a further aspect, there is provided a door for closing a doorway aperture defining at least one or more peripheral faces in a dual opening fashion, the door comprising:
a. a door member defining a pair of major faces and at least one or more minor faces at a peripheral edge of the major faces;
b. the door member being configured for connection to at least one or more pivoting arrangements in operation to thereby move between
   i. a closed position in which the door member is substantially aligned with the doorway aperture, and
   ii. an open position in which the door member is pivoted from alignment with the doorway aperture to either side of the doorway aperture;
c. wherein the cross-section of at least one of the minor faces of the door member is configured so that when the door is moved between an open and a closed position, the minor face remains proximate to at least one peripheral face of the doorway aperture.

In one embodiment, the cross-section of the at least one minor face is substantially semicircular.

In one embodiment, the door comprises a pivoting arrangement on which the door member is pivotable between its open position and its closed position.

In one embodiment, the door member defines an upper minor face and a lower minor face, and the pivoting arrangement is configured to be received within one or more selected from apertures and recesses in the upper minor face and the lower minor face.

In one embodiment, the door comprises a latching arrangement.

In one embodiment, the latching arrangement comprises a latch member.

In one embodiment, the latch member is configured for engaging with a latch plate from both sides of the doorway aperture in operation.

In one embodiment, when the door member is in its closed position in operation, the latch member is configured for being received into one or more selected from an adjustable aperture and a recess in the latch plate and/or the doorway aperture.

In one embodiment, the latch member is configured to be moved between
a. a movable condition in which the latch member is movable to allow movement of the door member between its open position and its closed position; and
b. a locked condition in which the latch member is locked in position to prevent movement of the door member from its closed position to its open position.

In one embodiment, the door comprises an airflow restricting assembly.

In one embodiment, the airflow restricting assembly comprises a rigid insert.

In one embodiment, the rigid insert is configured to be receivable within recesses arranged at least partially around the minor faces of the door member.

In one embodiment, the recesses are integrally formed into the minor faces of the door member.

In one embodiment, the recesses are detachable from the minor faces of the door member.

In one embodiment, the rigid insert is configured to be receivable within recesses arranged around the peripheral faces of the doorway aperture.

In one embodiment, the recesses are integrally formed into the peripheral faces of the doorway aperture.

In one embodiment, the rigid insert is configured to complement the shape of the recess.

In one embodiment, the recesses are detachable from the peripheral faces of the doorway aperture.

In one embodiment, the rigid insert is configured to comprise a restrictor arrangement.

In one embodiment, the thickness of the restrictor arrangement is adjustable.

In one embodiment now described, once the rigid inserts are received into the recesses, the restrictor arrangements are configured to extend into the gap between the minor faces of the door member and the doorway aperture to prevent or restrict airflow through that gap.

In one embodiment, when the rigid inserts are received into the recesses, adjustable restrictor arrangements are configured to extend into the gaps of varying thicknesses between the minor faces of the door member and the doorway aperture to prevent or restrict airflow through that gap.

According to a further aspect, there is provided a two-way door closing arrangement for closing a door located in a doorway aperture, the door being pivotably movable on a pivoting arrangement between a closed position in which the door is substantially in alignment with the doorway aperture, and an open position in which the door is movable out of alignment with the doorway aperture to either side of the doorway aperture, the door closing arrangement comprising:
a. a door engaging arrangement configured to be connectable to a door member and configured to pivot with the door member; and
b. a doorway aperture engaging arrangement configured to be rigidly coupled to the doorway aperture; and
c. a biasing arrangement configured for biasing movement of the door engaging arrangement relative to the doorway aperture engaging arrangement in operation to thereby bias movement of the door from its open position to its closed position.

In one embodiment, the two-way door closing arrangement is further configured to act as a pivoting arrangement on which a door is pivotable about a pivoting axis.

In one embodiment, the door engaging arrangement is further configured to act as a pivoting arrangement on which a door is pivotable about a pivoting axis.

In one embodiment, the biasing arrangement couples the door engaging arrangement to the doorway aperture engaging arrangement.

In one embodiment, the biasing arrangement comprises at least one biasing member.

In one embodiment, the biasing member is one or more selected from an elastically resilient blade spring and a helical spring.

In one embodiment, the biasing arrangement comprises a receiving member.

In one embodiment, the receiving member is configured for receiving at least part of the biasing member.

In one embodiment, the biasing arrangement is configured to allow for adjustability of the level of the bias provided by the biasing member.

In one embodiment, the biasing arrangement is configured to allow for adjustability of the biasing torque.

In one embodiment, the biasing arrangement comprises an adjusting arrangement.

In one embodiment, the adjusting arrangement comprises a manually manipulable member.

In one embodiment, the adjusting arrangement comprises one or more selected from a sliding aperture and a sliding recess into which the biasing member is receivable.

In one embodiment, the biasing member is configured for connection to the adjusting arrangement.

In one embodiment, the door engaging arrangement and doorway aperture engaging arrangement are pivotable relative to each other on an axis coaxial with the pivoting arrangement.

In one embodiment, the two-way door closing arrangement is configured for being received within one or more selected from a recess and an aperture in one or more selected from:
a. a peripheral face of the doorway aperture; and
b. the door member.

In one embodiment, the biasing arrangement comprises a coupling arrangement configured for coupling the door engaging arrangement to the doorway aperture engaging arrangement.

In one embodiment, the biasing arrangement comprises a coupling arrangement configured for adjustably coupling the door engaging arrangement to the doorway aperture engaging arrangement.

In one embodiment, the biasing member is engageable with engaging formations on the coupling arrangement.

In one embodiment, the coupling arrangement includes the biasing member.

In one embodiment, the doorway aperture engaging arrangement comprises a supporting bracket.

In one embodiment, the doorway aperture engaging arrangement is configured for fixedly engaging with the biasing arrangement.

In one embodiment, the doorway aperture engaging arrangement is configured for fixedly engaging with the receiving member.

In one embodiment, the supporting bracket defines a complementary receiving formation configured for receiving a locating formation on the receiving member.

In one embodiment, the locating formation is a spline formation.

In one embodiment, the receiving member defines a spline formation locatable in a complementary receiving formation defined by the supporting bracket.

In one embodiment, the receiving member comprises a receiving formation configured for slidably receiving the biasing member.

In one embodiment, the receiving formation defines a slot configured for receiving at least part of the biasing member.

In one embodiment, the supporting bracket is configured for being securely mounted in the doorway aperture.

In one embodiment, the supporting bracket is adapted for supporting a door member.

In one embodiment, the doorway aperture engaging arrangement further comprises a door support assembly configured for facilitating the support of the door member.

In one embodiment, the door support assembly comprises an adjustable support member and an adjustable locking connector.

In one embodiment, the adjustable support member is a bolt, and the adjustable locking connector is a nut.

In one embodiment, the bolt is receivable within one or more selected from a threaded aperture and a threaded recess in the supporting bracket.

In one embodiment, the threads of the bolt are suitably engageable with complementary internal threads in the lug and the supporting portion.

In one embodiment, the door engaging arrangement comprises a cylindrical housing.

In one embodiment, the door engaging arrangement further comprises a flange extending transversely to the longitudinal axis of the cylindrical housing.

In one embodiment, the door engaging arrangement further comprises securing formations on the flange configured for securing the door engaging arrangement to the door member.

In one embodiment, the door engaging arrangement further comprises securing formations on the flange configured for securing the door engaging arrangement to the doorway aperture.

In one embodiment, the securing formations comprise at least one or more securing ribs.

In one embodiment, the cylindrical housing is configured for snug engagement in a bore in a door member.

In one embodiment, the cylindrical housing is configured for snug engagement is a recess or bore in a doorway aperture.

In one embodiment, the securing ribs are configured for engagement with the door member to prevent rotation of the cylindrical housing

In one embodiment, the securing ribs are configured for engagement with the doorway aperture to prevent rotation of the cylindrical housing.

In one embodiment, the coupling arrangement is configured for being secured between one or more selected from:
a. the door engaging arrangement and the biasing arrangement; and
b. the doorway aperture engaging arrangement and the biasing arrangement.

In one embodiment, the coupling arrangement comprises:
a. a manually manipulable member; and
b. an adjustable securing pin (locating pin) configured for engagement within complementarily dimensioned holes in the cylindrical housing of the door engaging arrangement.

In one embodiment, the coupling arrangement comprises a biasing member and securing formations for securing the door engaging arrangement to the biasing member.

In one embodiment, the biasing member securing formation comprises a securing pin.

According to a further aspect, there is provided a door assembly for restricting access through a doorway aperture, the door assembly comprising:
a. a door as described, the door being configured for being received within a doorway aperture; and
b. a two-way door closing arrangement as described.

In one embodiment, the door assembly further comprises a latching arrangement configured for latching the door as it moves from an open position on either side of the doorway aperture to a closed position in which the door is substantially in alignment with the doorway aperture.

In one embodiment, the latching arrangement comprises a latch member movable between a retracted position and an extended position.

In one embodiment, the latch member is biased towards its extended position.

In one embodiment, the latch member comprises a biasing arrangement for biasing the latch member.

In one embodiment, the door assembly further comprises a latch plate configured for engagement with at least a portion of the doorway aperture.

In one embodiment, the latch plate defines a pair of angled surfaces at opposed ends of the latch plate, the angled surfaces being configured for engaging with and facilitating movement of the latch member as the door moves from its open position to its closed position in operation.

In one embodiment, the latch plate defines a pair of adjustable engagement lugs at opposed ends of the aperture, the engagement lugs being configured to securely receive the latch member within the aperture to firmly latch the door member when the door member is in the closed position.

In one embodiment, the door assembly comprises at least one hinge assembly.

In one embodiment, the at least one hinge assembly defines a pivot axis that extends through the door member.

In one embodiment, the at least one hinge assembly defines a pivot axis that extends through the door member, so that when the door member pivots, a curved minor face of the door member remains proximate to at least one peripheral face of the doorway aperture, irrespective of whether the door member is opening or closing.

In one embodiment, the pivot axis of the at least one hinge assembly extends through the door member, so that when the door member pivots, a curved minor face of the door member remains proximate to at least one peripheral face of the doorway aperture.

In one embodiment, the pivot axis of the at least one hinge assembly is coaxial with the pivoting axis of the two-way door closing arrangement.

In one embodiment, the coaxial pivot axis of the at least one hinge assembly and the two-way door closing arrangement extends through the door member.

In one embodiment, the coaxial pivot axis of the at least one hinge assembly and the two-way door closing arrangement extends through the door member, so that when the door member pivots, a curved minor face of the door member remains proximate to at least one peripheral face of the doorway aperture.

According to a further aspect, the present invention may be said to comprise of a door assembly for restricting access through a doorway aperture, the door assembly comprising:
a. a door member defining a pair of major faces and at least one or more minor faces at a peripheral edge of the major faces, wherein the cross-section of at least one of the minor faces of the door member is configured to be substantially curved, so that in operation when the door is moved between its open position and its closed position, the curved minor face remains proximate to at least one peripheral face of the doorway aperture;
b. a pivoting arrangement configured for facilitating pivotal movement of the door member about a pivot axis, the pivot axis extending through the door member proximate to the pivoting side.

In one embodiment, the pivoting arrangement comprises at least one hinge arrangement or hinge assembly.

In one embodiment, the pivoting arrangement comprises at least one two-way door closing arrangement as described above.

In one embodiment, the pivoting arrangement comprises a hinge assembly.

In one embodiment, the minor face is curved in a substantially semicircular shape in cross-section.

In one embodiment, the minor face substantially defines a part of a cylinder.

In one embodiment, the pivot axis of the hinge arrangement is substantially coaxial with the centre of the semicircular shape of the minor face.

In one embodiment, the pivot axis of the hinge arrangement is substantially coaxial with the longitudinal axis of said cylindrical minor face.

In one embodiment, the door assembly comprises a latch configured for latching the door as it moves from an open position on either side of the doorway aperture to a closed position in which the door is substantially in alignment with the doorway aperture.

In one embodiment, the latch comprises a latch member movable between a retracted position and an extended position.

In one embodiment, the latch member is biased towards its extended position.

In one embodiment, the latch comprises a biasing arrangement for biasing the latch member.

In one embodiment, the door assembly further comprises a latch plate configured for engagement with at least a portion of the doorway aperture.

In one embodiment, the latch plate defines a pair of angled surfaces at opposed ends of the latch plate, the angled surfaces being configured for engaging with and facilitating movement of the latch member as the door moves from its open position to its closed position in operation.

In one embodiment, the latch plate defines a pair of adjustable engagement lugs at opposed ends of the aperture, the engagement lugs being configured to securely receive the latch member within the aperture to firmly latch the door member when the door member is in the closed position.

In one embodiment, the door comprises an airflow restricting assembly.

In one embodiment, the airflow restricting assembly comprises a rigid insert.

In one embodiment, the rigid insert is configured to be receivable within recesses arranged around the minor faces of the door member.

In one embodiment, the recesses are integrally formed into the minor faces of the door member.

In one embodiment, the recesses are detachable from the minor faces of the door member.

In one embodiment, the rigid insert is configured to be receivable within recesses arranged around the peripheral faces of the doorway aperture.

In one embodiment, the recesses are integrally formed into the peripheral faces of the doorway aperture.

In one embodiment, the recesses are detachable from the peripheral faces of the doorway aperture.

In one embodiment, the rigid insert is configured to complement the shape of the recess.

In one embodiment, the rigid insert is configured to comprise a restrictor arrangement.

In one embodiment, the thickness of the restrictor arrangement is adjustable.

In one embodiment, the restrictor arrangement is flexible and may be integrally formed with, or glued to the rigid insert.

In one embodiment, the restrictor arrangements could be composed of flexible fibres.

In one embodiment, once the inserts are received into the recesses, the restrictor arrangements are configured to extend into the gap between the minor faces of the door member and the doorway aperture, to thereby prevent or restrict airflow through that gap.

In one embodiment, the restrictor arrangements configured to extend into the gap between the minor faces of the door member and the doorway aperture are adjustable to accommodate varying gaps between the minor faces of the door member and the doorway aperture to thereby prevent or restrict airflow through that gap.

According to a further aspect, there is provided a two-way door assembly for restricting access through a doorway aperture, the door assembly comprising:
a. a door member defining a pair of major faces and at least one or more minor faces at a peripheral edge of the major faces, wherein the cross-section of at least one of the minor faces of the door member is configured to be substantially curved, so that in operation when the door is moved between its open position from either side of the doorway aperture and its closed position, the curved minor face remains proximate to at least one peripheral face of the doorway aperture;
b. a hinge arrangement;
c. a door member defining a pair of major faces, the major faces defining at least one straight pivoting side at which at least one curved elongate minor face extends between the major faces; and
d. a hinge arrangement configured for facilitating pivotal movement of the door member about a pivot axis, the pivot axis extending through the door member proximate to the pivoting side.

In one embodiment, the minor face is curved in a substantially semicircular shape in cross-section.

In one embodiment, the minor face substantially defines a part of a cylinder.

In one embodiment, the pivot axis of the hinge arrangement is substantially coaxial with the centre of the semicircular shape of the minor face.

In one embodiment, the pivot axis of the hinge arrangement is substantially coaxial with the longitudinal axis of said cylindrical minor face.

In one embodiment, the hinge arrangement comprises a two-way door closing arrangement as described.

In one embodiment, the door assembly comprises a latch configured for latching the door as it moves from an open position on either side of the doorway aperture to a closed position in which the door is substantially in alignment with the doorway aperture.

In one embodiment, the latch comprises a latch member movable between a retracted position and an extended position.

In one embodiment, the latch member is biased towards its extended position.

In one embodiment, the latch comprises a biasing arrangement for biasing the latch member.

In one embodiment, the door assembly further comprises a latch plate configured for engagement at least a portion of the doorway aperture.

In one embodiment, the latch plate defines a pair of angled surfaces at opposed ends of the latch plate, the angled surfaces being configured for engaging with and facilitating movement of the latch member as the door moves from its open position to its closed position in operation.

In one embodiment, the latch plate defines a pair of adjustable engagement lugs at opposed ends of the aperture, the engagement lugs being configured to securely receive the latch member within the aperture to firmly latch the door member when the door member is in the closed position.

According to a further aspect, there is provided a door assembly for restricting access through a doorway aperture, the door assembly comprising:
a. a door member defining a pair of major faces and at least one or more minor faces at a peripheral edge of the major faces, wherein the cross-section of at least one of the minor faces of the door member is configured to be substantially curved, so that in operation when the door is moved between its open position from either side of the doorway aperture and its closed position, the minor face remains proximate to at least one peripheral face of the doorway aperture;
b. a pivoting arrangement;
c. a latching arrangement; and
d. an airflow restricting assembly.

In one embodiment, the airflow restricting assembly comprises a rigid insert.

In one embodiment, the rigid insert is preferably composed of plastic, metal, or the like.

In one embodiment, the rigid insert is configured to be receivable within recesses arranged around the minor faces of the door member.

In one embodiment, the recesses are integrally formed into the minor faces of the door member.

In one embodiment, the recesses are detachable from the minor faces of the door member.

In one embodiment, the rigid insert is configured to be receivable within recesses arranged around the peripheral faces of the doorway aperture.

In one embodiment, the recesses are integrally formed into the peripheral faces of the doorway aperture.

In one embodiment, the recesses are detachable from the peripheral faces of the doorway aperture.

In one embodiment, the rigid insert is configured to complement the shape of the recess.

In one embodiment, the inserts include barb formations that allow the inserts to be inserted into the recesses, and prevent the inserts from being easily removed from the recesses.

In one embodiment, the inserts could be located within the recesses using adhesives or other means that prevent the inserts from being easily removed from the recesses.

In one embodiment, the rigid insert is configured to comprise a restrictor arrangement.

In one embodiment, the thickness of the restrictor arrangement is adjustable.

In one embodiment, the restrictor arrangement comprises a preferably flexible configuration.

In one embodiment, the flexible restrictor arrangement may be integrally formed with, or glued to the rigid insert.

In one embodiment, the restrictor arrangements could be composed of a flexible rubber, silicon or other similar plastic.

In one embodiment, the restrictor arrangements could be composed of many small flexible fibres.

In one embodiment, once the inserts are received into the recesses, the restrictor arrangements are configured to extend into a gap between the minor faces of the door member and the doorway aperture in use, to thereby prevent or restrict airflow through that gap.

In one embodiment, the airflow restricting assemblies extend from recesses around the minor faces of the periphery of the door member and into gaps between the minor faces of the door member and the inner peripheral faces of the doorway aperture to thereby prevent or at least restrict the flow of air through these gaps.

In one embodiment, the airflow restricting assemblies extend from recesses around the inner peripheral faces of the doorway aperture and into gaps between the minor faces of the door member and the inner peripheral faces of the doorway aperture to thereby prevent or at least restrict the flow of air through these gaps.

In one embodiment, the airflow restricting assemblies may be receivable within recesses arranged around the inner peripheral faces of the doorway aperture or door jamb. It is envisaged that a recess and airflow restricting assembly will be provided on an inner peripheral face of the doorway aperture or door jamb at a point closest to the minor faces of the door member and the axis of the pivoting arrangement, preferably with the restrictor arrangement making contact with the curved elongate minor face of the door member. As the door member is moved between its open positions on either side of the doorway aperture and its closed position, the restrictor arrangement will remain in contact with the curved minor face of the door member throughout movement of the door member, thereby restricting the movement of air between the doorway aperture and the curved elongate minor face of the door member.

In a further embodiment, a series of parallel recesses may be provided on the pivoting arrangement side of the inner peripheral face of the doorway aperture, and airflow restricting assemblies provided for each of the parallel recesses in order to increase the effect of the airflow restricting assemblies.

In a further embodiment, a series of parallel recesses may be provided on all peripheral faces of the doorway aperture, and airflow restricting assemblies for each of the parallel recesses in order to increase the effect of the airflow restricting assemblies.

In a further embodiment, a series of parallel recesses may be provided on an upper minor, a lower minor, and the latching arrangement side of the door member; and airflow restricting assemblies provided for each of the parallel recesses in order to increase the effect of the airflow restricting assemblies.

In a further embodiment, the restrictor arrangements configured to extend into the gap between the minor faces of the door member and the doorway aperture are adjustable to accommodate varying gaps between the minor faces of the door member and the doorway aperture to thereby prevent or restrict airflow through that gap.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1: shows a cutaway top perspective view of a two-way door closing arrangement;

FIG. 2: shows an exploded top perspective view of a two-way door closing arrangement, showing two alternative biasing members;

FIG. 3: shows a top perspective view of a two-way door closing arrangement of FIG. 1;

FIG. 4a: shows a top view of a door showing close-up detail of airflow restricting assemblies;

FIG. 4b: shows a front view of the door of FIG. 4a;

FIG. 4c: shows a side view of a door showing close-up detail of airflow restricting assemblies;

FIG. 4d: shows a top perspective view of the door of FIG. 4c;

FIG. 4e: shows a top view of a door without airflow restricting assembly detail;

FIG. 4f: shows a front view of the door of FIG. 4e;

FIG. 4g: shows a side view of a door without airflow restricting assemblies;

FIG. 4h: shows a top perspective view of the door of FIG. 4g;

FIG. 5a: shows a side view of a door assembly;

FIG. 5b: shows a front view of a door assembly of FIG. 5a showing a detailed view of the pivoting arrangement;

FIG. 6: shows an exploded top view of a door assembly, showing a detailed view of the door jamb, door member, curved elongate minor face, latch member and latch plate;

FIG. 7: shows a top view of a door assembly showing the door member in many positions during various stages of operation, showing close-up detail of the latch member, latch plate, curved elongate minor face and pivot axis X;

FIG. 8: shows a top view of a door assembly showing close-up detail of the curved elongate minor face, pivot axis X, and proximity to the doorway aperture;

FIG. 9a: shows an exploded top perspective assembly view of a first embodiment hinge assembly for use at a lower minor face of a door;

FIG. 9b: shows a bottom perspective view of a hinge assembly of FIG. 9a without a bushing;

FIG. 9c: shows a top perspective view of a hinge assembly of FIG. 9a without a bushing;

FIG. 10a: shows a top perspective view of a second embodiment of a hinge assembly for use at an upper minor face of a door, without a bushing;

FIG. 10b: shows an exploded top perspective view of the hinge assembly of FIG. 10a, including a bushing;

FIG. 11: shows an exploded top perspective assembly view of a third embodiment of a hinge assembly for use at an upper minor face of the door including a bushing;

FIG. 12: shows an exploded top perspective view of the third embodiment of a hinge assembly of FIG. 11 and an upper minor face of the door member with a detailed view of the shaped recess, and the curved elongate minor face;

FIG. 13a: shows a top perspective view of a fourth embodiment of a hinge assembly, part of a first embodiment of a two-way door closing arrangement including a door engaging arrangement used in conjunction with a doorway aperture engaging arrangement, for use with an upper minor face of a door member, and a torsion lug;

FIG. 13b: shows a bottom perspective view of FIG. 13a;

FIG. 14: shows an exploded top perspective assembly view of a first embodiment of a two-way door closing arrangement, including a door engaging arrangement for use with an upper internal peripheral face of a doorway aperture, a doorway aperture engaging arrangement, and a torsion lug;

FIG. 15a: shows a top perspective view of a fifth embodiment of a hinge assembly, part of a second embodiment of a two-way door closing arrangement including a door engaging arrangement used in conjunction with a doorway aperture engaging arrangement, for use with a lower minor face of a door member, a torsion lug and a door support assembly;

FIG. 15b: shows a bottom perspective view of FIG. 15a;

FIG. 16: shows an exploded top perspective assembly view of a second embodiment of a two-way door closing arrangement, including a door engaging arrangement for use with a lower minor face of a door member, a doorway aperture engaging arrangement, a door support assembly, and a torsion lug;

FIG. 17a: shows a top perspective view of a latching arrangement, the latch member engaging the latch plate;

FIG. 17b: shows a top perspective view of a latch plate;

FIG. 18: shows an exploded top perspective assembly view of a latching arrangement, latch, latch member and latch plate;

FIG. 19a: shows a cutaway top exploded assembly view of a doorway aperture and airflow restricting assembly;

FIG. 19b shows a top view of a doorway aperture and airflow restricting assembly;

FIG. 19c: shows a close-up detail view of FIG. 19b;

FIG. 20: shows a cutaway top perspective view of a doorway aperture and airflow restricting assembly;

FIG. 21: shows an exploded top assembly perspective view of an upper doorway aperture and airflow restricting assembly; including a recess in the doorway aperture that accepts the securing ribs of the flange, securing the door engaging arrangement to the doorway aperture and preventing the door engaging arrangement from rotating within the doorway aperture;

FIG. 22: shows an exploded assembly perspective view of a lower minor face of a door member and airflow restricting assembly; disclosing the recess in the door member that accepts the securing ribs of the flange, securing the door engaging arrangement to the lower minor face of the door member and preventing the door engaging arrangement from rotating within the door member; and

FIG. 23: shows a close-up detail view of a lower minor face of a door member and airflow restricting assembly.

### DESCRIPTION OF EMBODIMENTS

With reference to the above drawings, in which similar features are generally indicated by similar numerals, a door according to a first aspect of the invention is generally indicated by the numeral 100, a two-way door closing arrangement according to a further aspect of the invention is generally indicated by the numeral 1000, and a door assembly according to a further aspect of the invention is generally indicated by the numeral 2000.

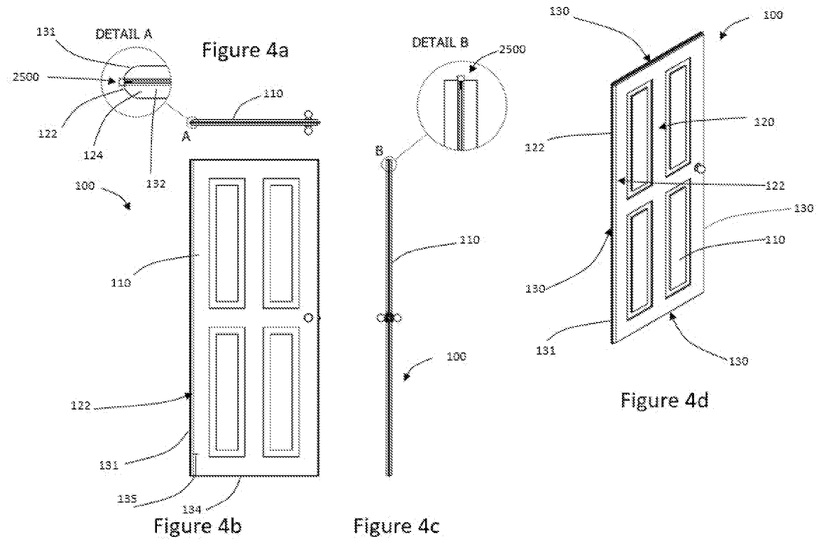

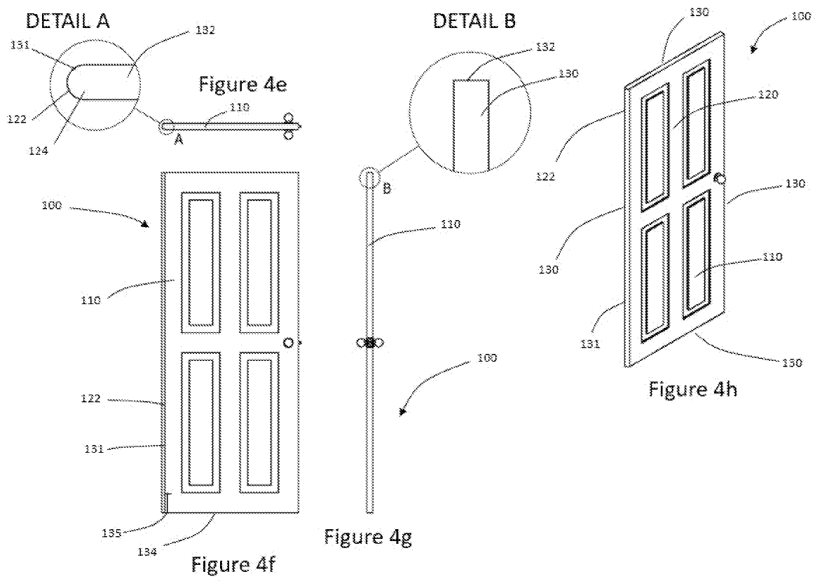

In one embodiment now described, and as shown in FIGS. 4a-8, there is provided a door assembly 2000. The door assembly 2000 is for restricting access through a doorway aperture (not shown) which may be surrounded by a door jamb 4000, door frame or the like. The door assembly 2000 comprises a door 100 and a two-way door closing arrangement 1000 as will be described in more detail below.

The door 100 is pivotably movable on a pivoting arrangement 2300 between a closed position in which the door is substantially in alignment with the doorway aperture to thereby restrict access through the doorway aperture, and an open position in which the door is movable to either side of the doorway aperture to thereby allow access through the doorway aperture. The pivoting arrangement 2300 will be described in more detail below.

The door 100 comprises a door member 110 that defines a pair of major faces 120, preferably rectangularly shaped, and four minor faces (130 corresponding to the sides of the major faces 120) at the periphery of the major faces 120. The major faces 120 define at least one straight pivoting side 122 at which at least one curved elongate minor face 131 extends between the major faces. The door 100 in operation will be pivotably secured along the pivoting side 122 within the doorway.

The curved minor face cross-section 124 of the curved elongate minor face 131 at the straight pivoting side 122 of the door member is configured to be substantially curved, so that in operation when the door member is moved between its open position on either side of the doorway aperture and closed position, and vice versa, the curved elongate minor face 131 remains proximate to the doorway aperture. In one preferred embodiment, the curved minor face cross-section 124 of the curved elongate minor face 131 is substantially semicircular, with the curved elongate minor face 131 defining part of a cylindrical shape.

In addition to the curved elongate minor face 131 extending along the pivoting side 122 of the major faces of the door member 110, the door member also defines an upper minor face 132 and a lower minor face 134 as will be described in more detail below.

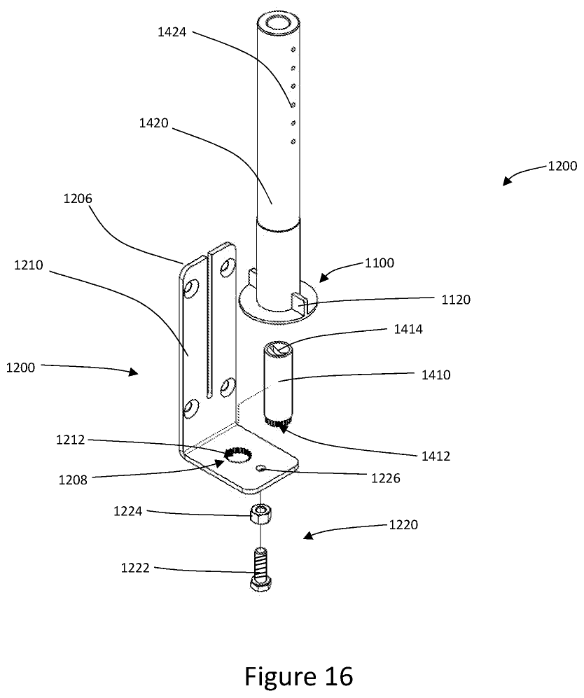

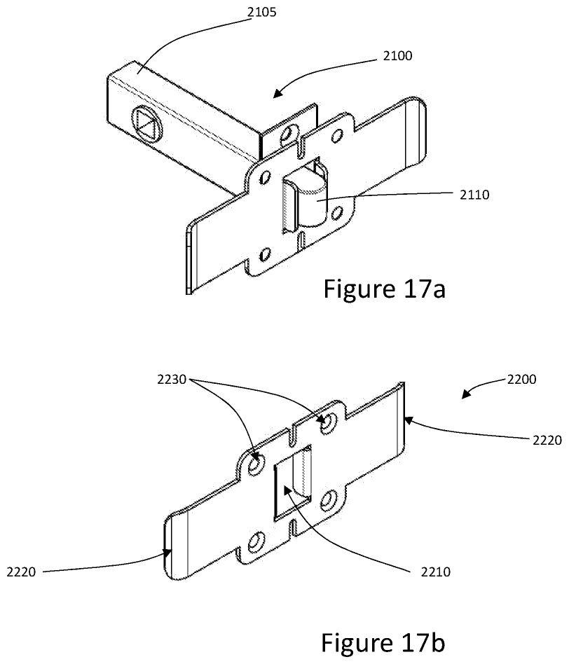

The door assembly 2000 further comprises a latching arrangement 2100 (as shown in more detail in FIGS. 17 and 18), a latch member 2110 engageable with a latch plate 2200 that is mounted to an inner surface of the doorway aperture. In one embodiment the latch plate defines a pair of adjustable engagement lugs at opposed sides of the aperture, the engagement lugs being configured to securely receive the latch member within the aperture to firmly latch the door member when the door member is in the closed position.

The latching arrangement 2100 is configured for latching the door 100 as it moves from its open position to its closed position.

The latching arrangement 2100 comprises a latch member 2110 that is movable between a retracted position and an extended position, and is preferably biased towards its extended position by a biasing arrangement such as a spring, resiliently elastic member, or the like (not shown). When the door member 110 is in its closed position, the latch member 2110 is receivable within an aperture 2210 in the latch plate 2200. The latch plate 2200 further defines a pair of angled surfaces 2220 at opposed ends of the latch plate 2200, and a pair of adjustable engagement lugs 2240 at opposed ends of the aperture 2210. In an alternative embodiment (not shown), the aperture 2210 could alternately be in the form of a recess 2212.

As the door member 110 moves towards its closed position from either side of the doorway aperture, the latch member 2110 engages with one of a pair of angled surfaces 2220 that are located at opposed ends of the latch plate 2200. The angled surfaces 2220 initiate movement of the latch member 2110 to move from its extended position towards its retracted position, allowing the latch member 2110 to slide over the latch plate 2200 unhindered. When the door member 110 is in its closed position, the latch member 2110 extends and is in alignment with the aperture 2210 in the latch plate 2200, and the latch member 2110 is securely received within the aperture 2210 as defined by the adjustable engagement lugs 2240 to latch the door member 110, thereby preventing further movement of the door member.

The latch plate 2200 includes four mounting apertures 2230 disposed on the centre portion which allow for it to be mounted to a door jamb 4000 (not shown) or periphery of the doorway aperture (not shown) by use of screws or nails.

The latching arrangement 2100 can further comprise a locking mechanism (not shown) configured for locking the latch member 2110 in position when received in the aperture 2210 , to thereby lock the door member. In an alternative embodiment, it is envisaged that the locking mechanism could include additional locking members (not shown) that are movable between an extended position and a retracted position in known manners, such as deadbolts or the like.

As described above, the door assembly 2000 further comprises a pivoting arrangement 2300 defining a pivot axis X on which the door member 110 is pivotable. In one embodiment, the pivot axis of the hinge assembly may extend through the door member, so that when the door member pivots, a curved minor face of the door member remains proximate to at least one peripheral face of the doorway aperture.

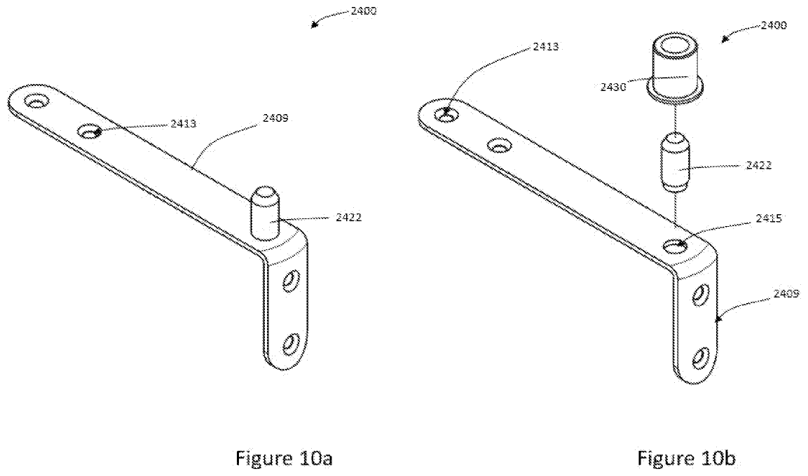

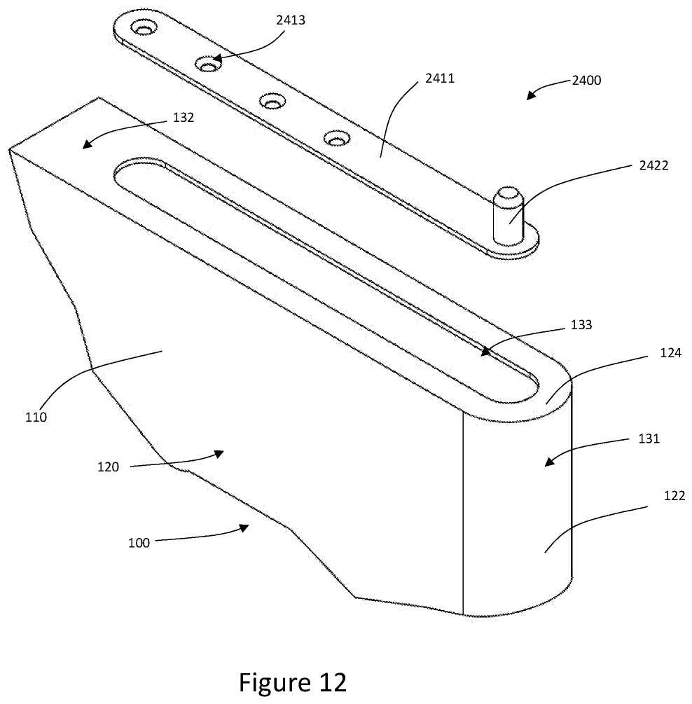

The pivoting arrangement 2300 preferably comprises a hinge assembly 2400; or alternately, an embodiment of a doorway aperture engaging arrangement 1200 and at least one two-way door closing arrangement 1000. In one embodiment shown in FIGS. 11 and 13, the hinge locating plate 2411 or hinge locating plate 1130 is preferably located at, and received within a shaped recess 133 in the upper minor face 132 of the door member 110. The door closing arrangement 1000 includes a door engaging arrangement, that is for engagement with a door, a doorway aperture engaging arrangement that is for engaging with a doorway aperture, a biasing arrangement for biasing movement of the door to a central position, and a coupling arrangement for coupling with the biasing arrangement.

The biasing arrangement can be associated with either of the door engaging arrangement or the doorway aperture engaging arrangement, while the coupling arrangement serves to coupe the biasing arrangement to the door engaging arrangement or the doorway aperture engaging arrangement that the biasing arrangement is not associated with.

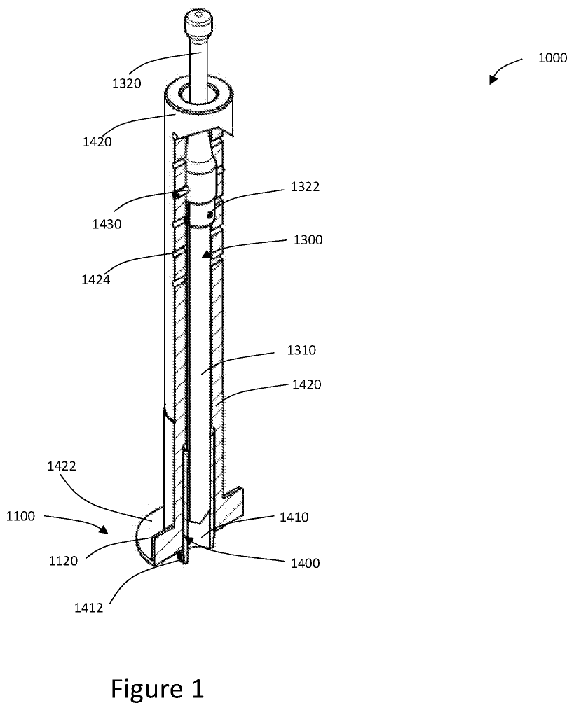

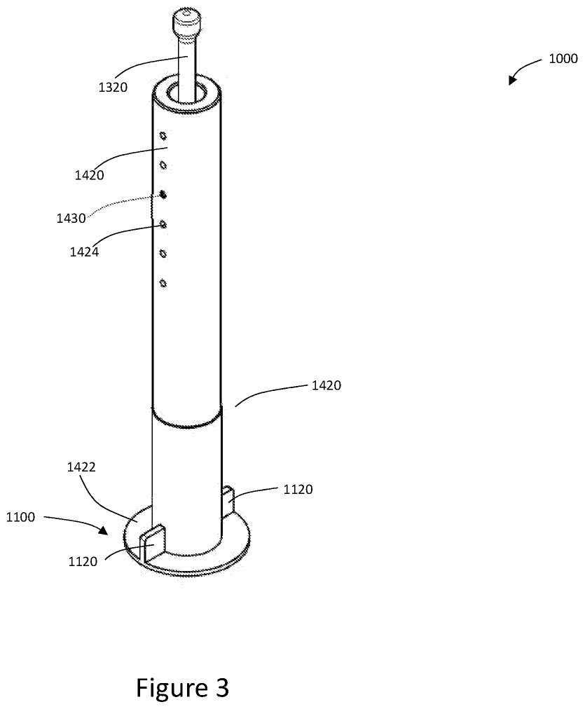

In one embodiment the two-way door closing arrangement 1000 (shown in FIGS. 1-3) is preferably disposed adjacent to, and partly received into a recess (not shown) in an upper internal peripheral face of the doorway aperture. The door engaging arrangement includes a hinge locating plate recessed in the top of the door member and is associated with the coupling arrangement 1400. The coupling arrangement 1400 includes a receiving member in the form of a torsion slot 1410.

In an alternative and/or further embodiment, the two-way door closing arrangement 1000 is preferably disposed adjacent to, and received into a recess or bore 135 within the lower minor face 134 of the door member 110 above the torsion lug 1410 when used in conjunction with doorway aperture engaging arrangement 1200 supporting bracket 1206. The two-way door closing arrangement 1000 also facilitates the pivoting of the door member 110, and will be described in more detail below.

It is envisaged that the preferred location of the two-way door closing arrangement 1000 determines when the pivoting arrangement 2300, comprising the hinge assembly 2400, could be partially interchanged with the hinge assembly 1200. In yet another embodiment it is envisaged that two two-way door closing arrangements 1000 could be used exclusively in conjunction with hinge assembly 1200. The pivot axes of the hinge assemblies 2400 and 1200, and the two-way door closing arrangement 1000 are coaxial, and preferably extend through the door member 110 to define the pivot axis X on which the pivoting arrangement 2300 is pivotable. In a further embodiment, when no door closing arrangement is commissioned, hinge assembly 2400 is the pivot axis of pivoting arrangement 2300.

In a preferred embodiment, the coaxial pivot axes of the hinge assembly and the two-way door closing arrangement extend through the door member 110, so that when the door member pivots, the curved elongate minor face 131 of the door member 110 remains proximate to at least one peripheral face of the doorway aperture. In a preferred embodiment, the coaxial pivot axes of the hinge assembly and the two-way door closing arrangement will extend along the longitudinal axis of the cylindrical curved elongate minor face 131, in other words the coaxial pivot axes extend through the centre of the semicircular curved minor face cross-section 124 of the straight pivoting side minor face 122 of the door member 110, defining the pivot axis X.

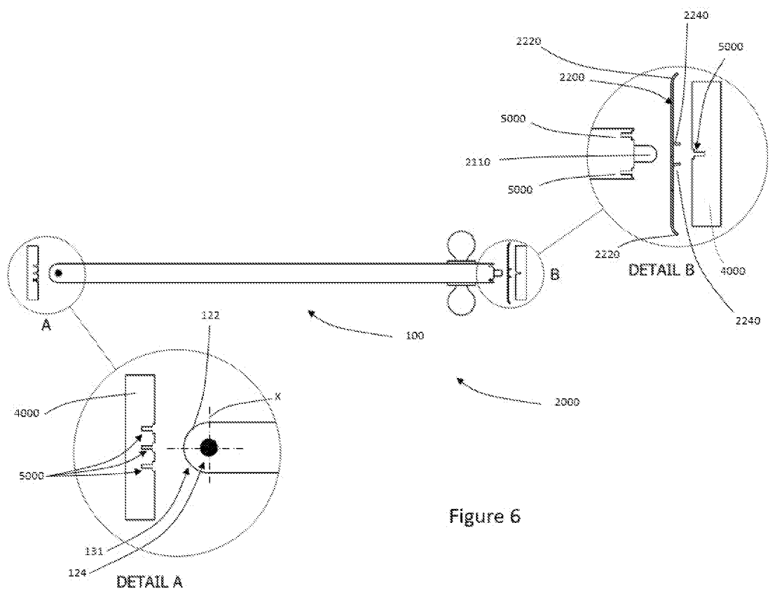

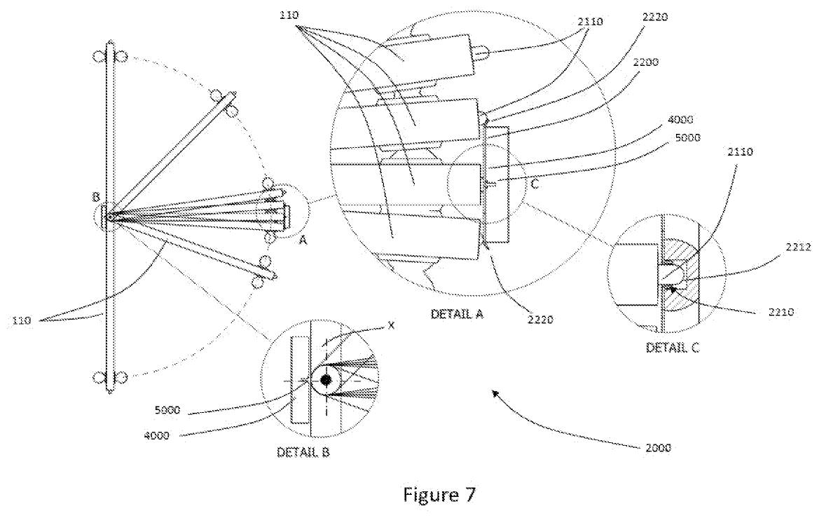

As shown in FIGS. 7 and 8, the door assembly 2000 is shown in various stages of operation. It will be appreciated that whilst FIG. 7 depicts the interaction of the latch member and latch plate as the door is being closed from a first direction to the door jamb, the following description is similarly applicable when the door is swung or propelled closed from the opposite side of the door frame.

As the door member is shown being swung towards the closed position (shown in FIG. 7: Detail A), the latch member has yet to abut against a first curved end of the latch plate. The latch member is still extended outwardly of the door edge due to the biasing of the latch member into the extended position.

As the door member moves towards its closed position, the latch member 2110 engages one of the angle surfaces 2220 of the latch plate, and the latch member is caused to deflect towards its retracted position. The latch member 2110 is also able to be readily deflected towards its retracted position when the door member 110 is swung from the opposite side of the doorway aperture into the closed position as the latch member engages with the angled surface 2220 on the opposed side of the latch plate 2200.

Detail C of FIG. 7 shows the door member when it is in the closed position and the latch member has extended outwardly of the periphery of the door aperture to its biasing position so as to be received through the aperture 2210 in the latch plate 2200 to be received into a recess 2212 in the inner peripheral face of the doorway aperture.

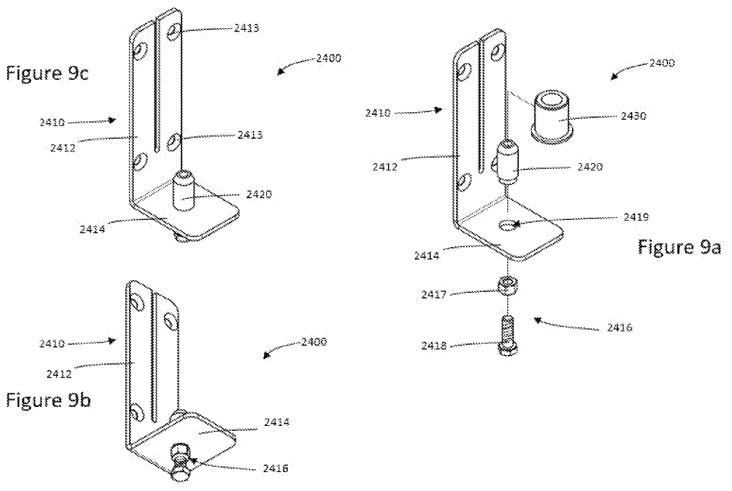

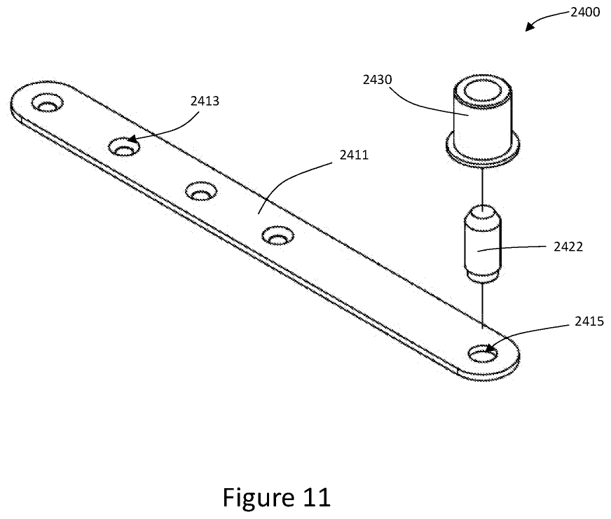

As shown in more detail in FIGS. 10-12, the hinge assembly 2400 located towards the upper minor face 132 of the door member comprises a locating plate 2409 or 2411 that is configured for location within a complementarily shaped recess 133 in the upper minor face 132 of the door member 110, and a lug 2422 received into aperture 2415 to engage with the locating plate. The lug 2422 is configured and dimensioned to be received within a bushing 2430. The bushing 2430 is in turn configured and dimensioned to be received within a recess (not shown) in an upper internal peripheral face (not shown) of the doorway aperture. The lug 2422 acts as a pivot axle and is rotatable inside the bushing 2430. In an alternative embodiment hinge locating plate 2409 may be configured for location within a complementarily shaped recess (not shown) on the door member 110 as well.

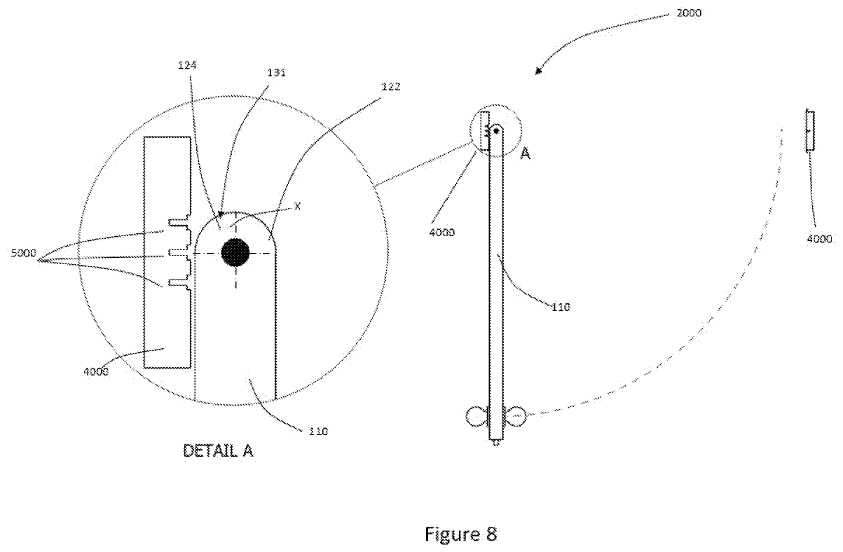

In an alternative embodiment shown in FIG. 9, the hinge assembly 2400 can be located at the lower minor face 134 of the door member 110. In this embodiment the hinge locating plate 2410 is L-shaped, and comprises a locating portion 2412 that is configured to be secured to a complementarily shaped recess (not shown) on an adjacent internal peripheral face of the doorway aperture via screw apertures 2413, and a supporting portion 2414 that extends outwardly from the locating portion.

The supporting portion 2414 is supported on the ground by a floor engaging formation 2416 that is configured for supporting the supporting portion 2414 on the floor or ground. The floor engaging formation 2416 comprises an adjustable assembly in the form of a lock nut 2417 and bolt 2418 that is receivable through an aperture 2419 in the supporting portion 2414 of the locating plate 2410, with the threads of the bolt 2418 being suitably engageable with complementary internal threads in lug 2420. The lug 2420 locates in the aperture 2419, preferably in a non-pivotable manner.

In operation, it is envisaged that the bolt will be screwed downwards out of lug 2420 and adjusted to rest on the floor with the lock nut being screwed along the bolt, the lock nut being located just underneath the supporting portion 2414 of the locating plate 2410. In this way, the weight of the door member 110 is supported by the floor engaging formation 2416, rather than relying on the rigidity of the locating plate 2410 for such support. However, it is envisaged that the floor engaging formation 2416 need not be required in an alternative embodiment, with the locating plate 2410 merely being designed robust enough to support the weight of the door member 110.

The lug 2420 is receivable within a bushing 2430. The bushing 2430 is in turn receivable within a recess (not shown) in the lower minor face 134 of the door 100. The bushing 2430 is rotatable around the lug 2420, the lug 2420 acting as a pivot axle.

Where the hinge assembly 2400 is located at the upper minor face 132 of the door member 110, it is envisaged that a two-way door closing arrangement 1000 and doorway aperture engaging arrangement 1200 will be provided at the lower minor face 134 of the door member, and vice versa.

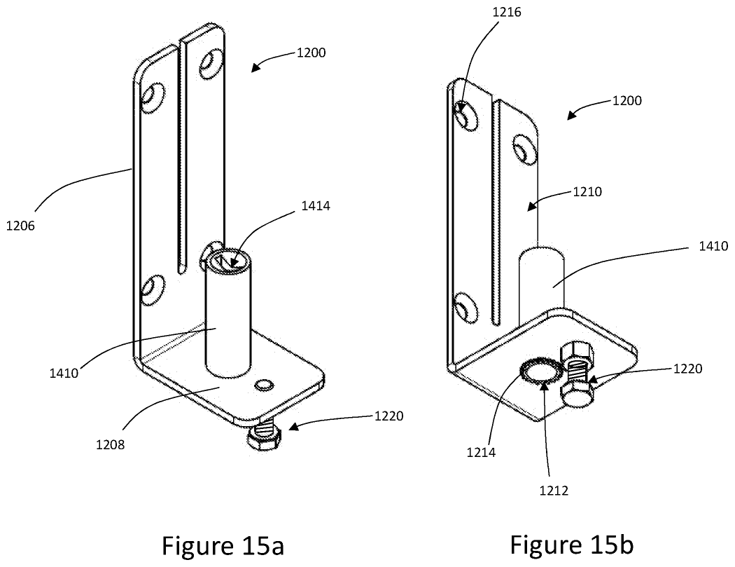

Details of one embodiment of a two-way door closing arrangement 1000 are shown in FIGS. 1-3 and 13-16. In FIG. 16, the two-way door closing arrangement 1000 is configured for being coupled between the door jamb 4000 and a lower minor face 134 of the door member 110. The two-way door closing arrangement comprises a door engaging arrangement 1100 configured to be fixedly connectable to a lower minor face 134 of the door member 110 and pivot with the door member, a doorway aperture engaging arrangement 1200 configured to be rigidly coupled to the doorway aperture, and a biasing arrangement 1300 and coupling arrangement 1400 for coupling the door engaging arrangement 1100 and doorway aperture engaging arrangement 1200 to each other with torsion lug 1410 in a pivoting manner.

The biasing arrangement 1300 is configured for biasing pivoting movement of the door engaging arrangement 1100 relative to the doorway aperture engaging arrangement 1200 in operation, to thereby bias movement of the door from its open positions to its closed position. The biasing arrangement 1300 comprises a biasing member 1310 that is preferably engageable with engaging formations 1414 on the coupling arrangement 1400 as will be described in more detail below. The biasing arrangement 1300 preferably further comprises an adjusting arrangement 1315 in the form of a manually manipulable connecting formation 1320 that allows for adjustment of the level of bias by the biasing arrangement as will be described in more detail below.

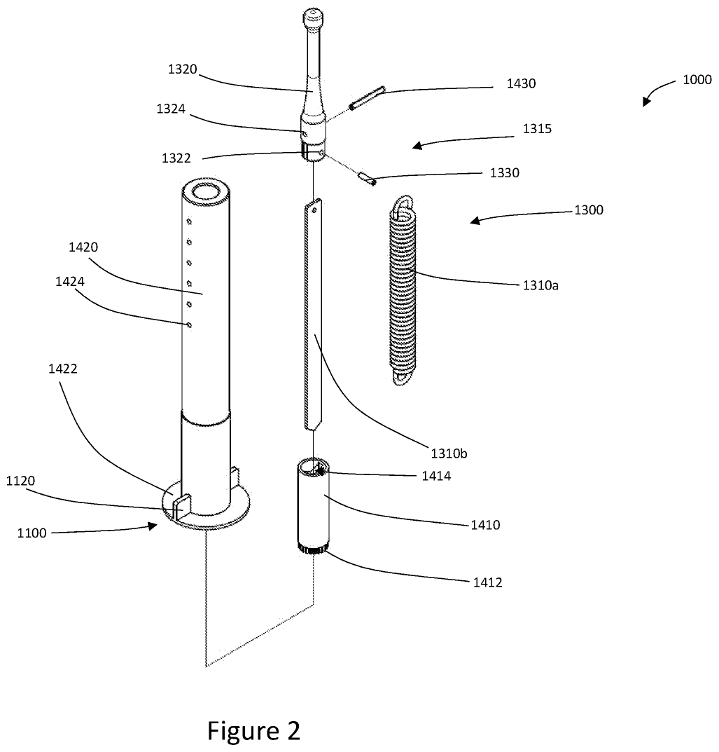

Two possible examples of a biasing member 1310 are shown in FIG. 2 as a helical spring 1310a and an elastically resilient blade spring 1310b (preferably composed of spring steel), although it will be appreciated by a person skilled in the art that many other configurations and embodiments are possible, such as an elastically resilient member such as a rubber compression member, a plastic member or the like.

As described above, the door engaging arrangement 1100 and doorway aperture engaging arrangement 1200 are coupleable to each other in a pivotable fashion by a coupling arrangement 1400, and the relative pivot axis is preferably on an axis coaxial with the hinge assembly 1200 on a pivoting arrangement 2300. In a further embodiment, components of hinge assembly 2400 are interchangeable with hinge assembly 1200 on a pivoting arrangement 2300, and the relative pivot axis is still preferably on an axis coaxial with the hinge assembly 2400.

The coupling arrangement 1400 comprises a torsion lug 1410, which is snugly receivable in a pivoting manner into a cylindrical housing or tubular socket formation 1420. In the embodiment where the tubular socket formation 1420 is in-situ in the recess or bore 135 in the lower minor face 134 of the door member 110, the torsion lug 1410 acts as a pivot axle around which the tubular socket formation 1420 is pivotable. The torsion lug 1410 is partially receivable within a splined aperture 1212 in the supporting portion 1208 of supporting bracket 1206 in a non-pivoting manner. Preferably, the torsion lug 1410 is provided with complementary receiving formations in the form of spline formations 1412 that are engageable with complementary spline formations 1214 on the inside of the aperture 1212 to thereby prevent rotation or pivoting of the torsion lug 1410 relative to the supporting bracket 1206. In turn, the tubular socket formation is configured for snug engagement in a recess or bore 135 in a lower minor face 134 in a door member 110, not to rotate within the recess or bore.

The tubular socket formation 1420 comprises a flange 1422 extending radially and transversely to its longitudinal axis. The flange 1422 facilitates the location of the tubular socket formation 1420 within a complementarily shaped recess or bore 135 in the lower minor face 134 of the door member 110.

A pair of securing formations in the form of securing ribs 1120 are part of the door engaging arrangement 1100, and function to engage with the door member 110 to prevent rotation or movement of the tubular socket formation 1420 relative to the door member. The securing ribs 1120 extend from the flange 1422 in a longitudinal and radial direction relative to the tubular socket formation 1420. In operation, the securing ribs 1120 will engage within the recess 5000 located on either side of bore 135 in which the tubular socket formation 1420 is seated, and which prevents pivoting movement of the tubular socket formation 1420 relative to the recess 5000. It will be appreciated that a wide variety of door engaging arrangements 1100 are possible, including embodiments applying the use of adhesives or fasteners such as screws (not shown).

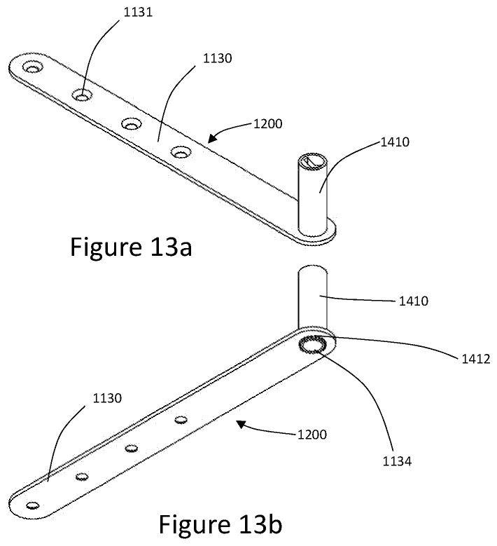

In FIGS. 13-14, the two-way door closing arrangement is configured for being coupled between the upper door jamb 4000 and an upper minor face 132 of the door member 110. In the embodiment shown in FIGS. 13-14, the torsion lug 1410 engages with the door engaging arrangement 1100, and a locating plate 1130 that is receivable into a recess 133 in the upper minor face 132 of the door member 110, similar in configuration to the locating portion 2411 of the hinge assembly 2400 for use at an upper minor face 132 of the door member 110. The two-way door closing arrangement comprises the door engaging arrangement 1100 configured to be fixedly connectable to, and not to rotate within a recess or bore in the upper internal peripheral face of the door jamb 4000, the doorway aperture engaging arrangement 1200 configured to be rigidly coupled to the upper minor face 132 of the door member 110, the torsion lug 1410 which pivots and rotates within the door engaging arrangement 1100, and the biasing arrangement 1300 and coupling arrangement 1400 for coupling the door engaging arrangement 1100 and doorway aperture engaging arrangement 1200 to each other with torsion lug 1410 in a pivoting manner. The biasing arrangement 1300 is configured for biasing pivoting movement of the doorway aperture engaging arrangement 1200 in operation relative to the door engaging arrangement 1100, the door engaging arrangement 1100 now being in-situ in the doorway aperture above the door member 110, to thereby bias movement of the door from its open positions on either side of the doorway aperture to its closed position. The coupling arrangement 1400 comprises a torsion lug 1410, which is snugly receivable in a pivoting manner into the cylindrical housing or tubular socket formation 1420. The torsion lug 1410 acts as a pivot axle and is pivotable within the stationary tubular socket formation 1420. The locating plate 1130 also defines an aperture 1132 defining complementary spline formations 1134 for engaging with spline formations 1412 on the torsion lug 1410. In the embodiment of the door engaging arrangement 1100 of the embodiment of the two-way door closing arrangement 1000 shown in FIGS. 13-14, the securing ribs 1120 extending from the flange 1422 engage with the recess 5000 in the upper internal peripheral face of the door jamb 4000, instead of the door member 110, to prevent pivoting or rotational movement of the tubular socket formation 1420 relative to the door jamb 4000.

As shown in FIG. 2 in an exploded assembly view, biasing member 1310a or 1310b is engageable with engaging formations located towards either end of the biasing member. The biasing arrangement 1300 also preferably comprises an adjusting arrangement as described below, allowing the torsional stiffness of the biasing member to be adjusted.

One of the engaging formations acts as a receiving member in that it includes a receiving formation 1414 in the form of a slot on the torsion lug 1410 by which the biasing member 1310a or 1310b is engageable with the coupling arrangement 1400. The slot 1414 is configured for receiving one end of the helical spring 1310a, and in a further embodiment, one end of the resilient blade spring 1310b, which extends upwardly through an inner passage of the tubular socket formation 1420. At its opposed end, the helical spring 1310a or the resilient blade spring 1310b is secured to the adjusting arrangement 1315 via locating pin 1330 into aperture 1322, and then to the tubular socket formation 1420 via locating pin 1430 that is adjustably locatable by inserting pin 1430 through aperture 1324 and one of the apertures 1424 in the tubular socket formation 1420 simultaneously.

The other of the engaging formations is a manually manipulable connecting formation 1320 that the helical spring 1310a or resilient blade spring 1310b is securable to by locating pin 1330 receivable into aperture 1322. In turn, the connecting formation 1320 can be secured to the tubular socket formation 1420 by a locating pin 1430 that is receivable into one of the apertures 1424. The locating (or securing) pin 1430 also prevents the manually manipulable connecting formation from rotating within the tubular socket formation 1420.

As shown in FIG. 2, the tubular socket formation 1420 defines a series of pairs of locating holes 1424 along its length, into which locating pin 1430 is inserted to secure the end of the helical spring 1310a or the resilient blade spring 1310b to the tubular socket formation 1420 (via the manually manipulable connecting formation 1320) at any one of the pairs of locating holes 1424. The lower down that the locating pin 1430 is located in the locating holes 1424, the shorter the distance will be to the slot 1414, thereby reducing the effective torsion resisting length of the resilient blade spring 1310b, and increasing its torsional stiffness. The higher the torsional stiffness, the greater the torsional force exerted to move the door from its open position to its closed position. The torsional stiffness of the helical spring 1310a can be adjusted by exchanging it with a helical spring of lesser or greater torsional resistance.

It will be appreciated by those skilled in the art that in alternative embodiments that the helical member or resilient blade member could be connected in a fixed fashion to either of the doorway aperture engaging arrangement or the door engaging arrangement, and that it could be slidably engageable with the other.

In operation, the helical spring 1310a or the resilient blade spring 1310b will initially be secured to the manually manipulable connecting formation 1320 by locating pin 1330. The manually manipulable connecting formation 1320 will then be inserted into the tubular socket formation 1420 to extend from its top end. The connecting formation 1320 can then be manually aligned by a user to align the aperture 1324 with the locating holes 1424 of the tubular socket formation 1420, and locating pin 1430 inserted. In this way, a user can choose the torsional stiffness of the biasing arrangement 1300.

The torsion lug 1410 located on either, or both, of the hinge assemblies 1200, is inserted into the bottom of the tubular socket formation 1420, into the door engaging arrangement 1100, and coupled with the helical spring 1310a or resilient blade spring 1310b, so that the end of the helical spring 1310a or the elastically resilient blade spring 1310b is received into the slot 1414.

It is envisaged that the tubular socket formation 1420 comprising the manually manipulable connecting formation 1320, the adjusting arrangement 1315 and the biasing arrangement 1300 is inserted into the recess or bore 135 located in the lower minor face 134 of the door member 110 so that the securing ribs 1120 will insert into the recess 5000 when the flange 1422 contacts the lower minor face 134 of the door member 110.

The biasing arrangement 1300, located within the tubular socket formation 1420, is inserted into recess 1414 of the torsion lug 1410 located within the splined aperture 1212 of the supporting portion 1208 of the doorway aperture engaging arrangement 1200 when the door member 110 is engaged with the doorway aperture engaging arrangement 1200 by coupling the door engaging arrangement 1100 with the torsion lug 1410; thereby effecting the coupling arrangement 1400 of the two-way door closing arrangement 1000.

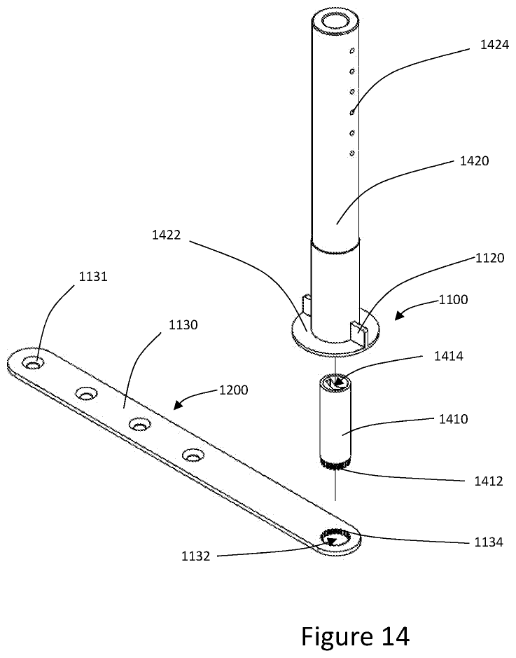

It is envisaged that the two-way door closing arrangement 1000 will be receivable within a recess or bore 135 in the lower minor face 134 of the door member 110, and inserted until the flange 1422 contacts the lower minor face 134 of the door member 110, the securing ribs 1120 engaging the recess 5000 in the lower minor face 134 of the door member 110. Such an embodiment is illustrated in FIGS. 15 and 16. In this way, the two-way door closing arrangement 1000 can be hidden away inside the door member 110 for better aesthetics. In certain embodiments the flange 1422 may be recessed into the lower minor face 134 of the door member for improved aesthetic appeal.

In an alternative embodiment shown in FIGS. 13 and 14, the two-way door closing arrangement 1000 is utilised in association with the upper minor face 132 of the door member 110. It is envisaged that the hinge locating plate 1130 will be receivable within a recess 133 in the upper minor face 132, and the two-way door closing arrangement 1000 will be receivable within the door jamb 4000 or other recess or bore (not shown) in an upper internal peripheral face of the doorway aperture above the upper minor face 132 of the door member 110, and inserted until the securing ribs 1120 insert into the recess 5000 when the flange 1422 contacts the door jamb 4000. In this way, the two-way door closing arrangement 1000 is secured and cannot rotate, and can be hidden away inside the door jamb 4000 for better aesthetics. In alternative embodiments the flange 1422 can be recessed into the upper internal peripheral face of door jamb 4000 for improved aesthetic appeal. It is also envisaged that in an alternative embodiment, a pair of two-way door closing arrangements 1000 can be provided for use in association with each of the upper minor face 132 and the lower minor face 134 of the door member 110.

The coupling arrangement 1400 is configured for coupling the door engaging arrangement 1100 to the doorway aperture engaging arrangement 1200.

In the embodiment shown in FIGS. 15a, 15b and 16, the doorway aperture engaging arrangement 1200 comprises a supporting bracket 1206. In the embodiments shown in FIGS. 15a, 15b and 16, the supporting bracket 1206 has a similar configuration to the locating plate 2410 used for the hinge assembly 2400 (as shown in FIGS. 9a, 9b and 9c) used in association with the lower minor face 134 of the door member 110, in that it is L-shaped, and also comprises fastening apertures 1216 by which the locating portion 1210 can be fastened within a complementarily shaped recess of the door jamb 4000. Similarly, the supporting bracket 1206 can be supported by a door support assembly 1220 that is similar to the floor engaging formation 2416 shown for the hinge assembly 2400 in that it preferably comprises a bolt 1222 and a lock nut 1224. Bolt 1222 engages with internal threads in a threaded aperture 1226 in the supporting portion 1208, and is locked in that position by the lock nut 1224. In an alternative arrangement and embodiment, it is envisaged that the bolt 1222 can engage with internal threads in the torsion lug 1410.

Preferably, a hinge assembly 2400 can be transformed for use with a two-way door closing arrangement 1000 by substituting lug 2420, and/or lug 2422 with torsion lug 1410, and substituting the relevant bushing 2430 with the two-way door closing arrangement 1000, to include the door engaging arrangement 1100, the coupling arrangement 1400 and biasing arrangement 1300. In the embodiments shown in FIGS. 13 and 14, the torsion lug 1410 and locating plate 1130 is substituted for lug 2422 and locating plate 2411, to now engage with a door engaging arrangement 1100 which replaces bushing 2430, as shown when comparing FIGS. 11 and 14. The two-way door closing arrangement 1000 (including the door engaging arrangement 1100, the biasing arrangement 1300 and coupling arrangement 1400) substituted for the bushing 2430 is receivable into a recess which may be required to be deeper in the upper internal peripheral face of the doorway aperture or door jamb 4000; and/or deeper in the lower peripheral minor face 134 of the door member 110.

It will be apparent to those skilled in the art that the configuration of the door assembly 2000 described above may allow for the flow of air around the outside of the door, since the door member 110 does not abut against door stops such as those found in common prior art door assemblies. For this reason, the door assembly 2000 is provided with airflow restricting assemblies 2500 that extend around the periphery of the door member 110, and into gaps between the minor faces of the door member 110 and the inner peripheral faces of the doorway aperture and/or door jamb 4000 and the floor, to thereby prevent or at least restrict the flow of air through these gaps.

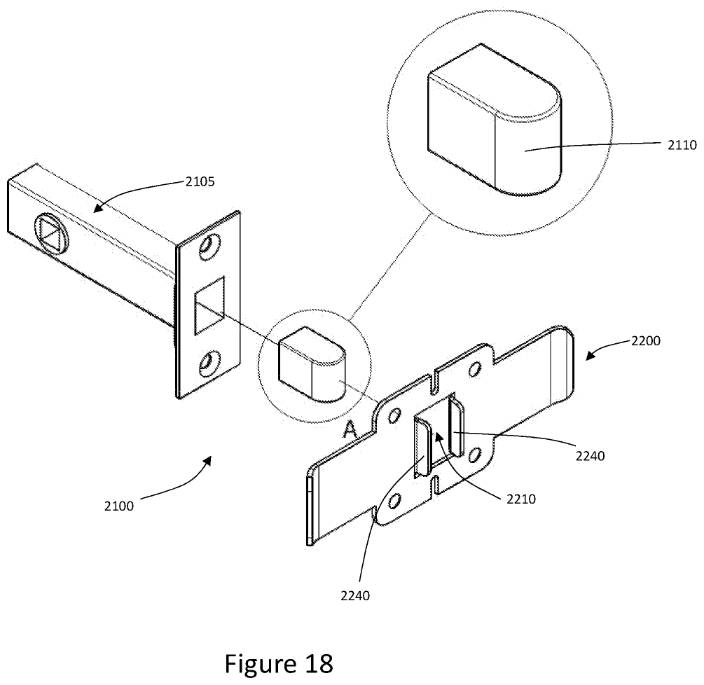

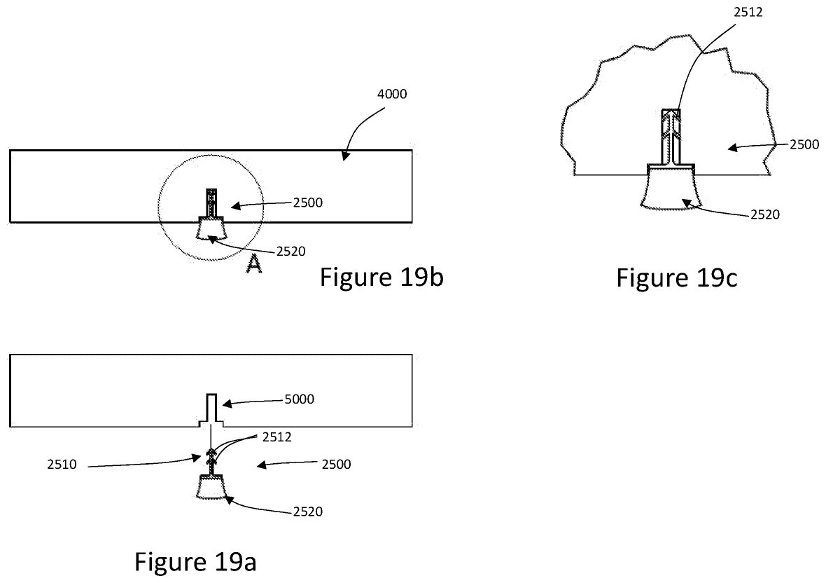

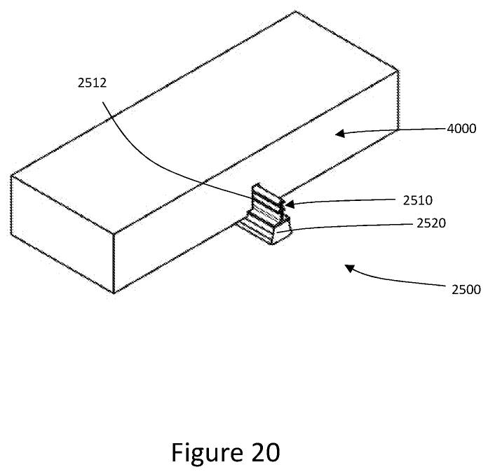

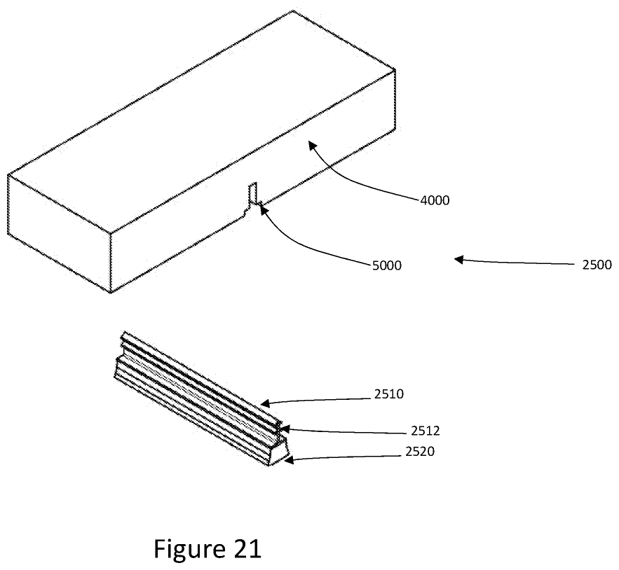

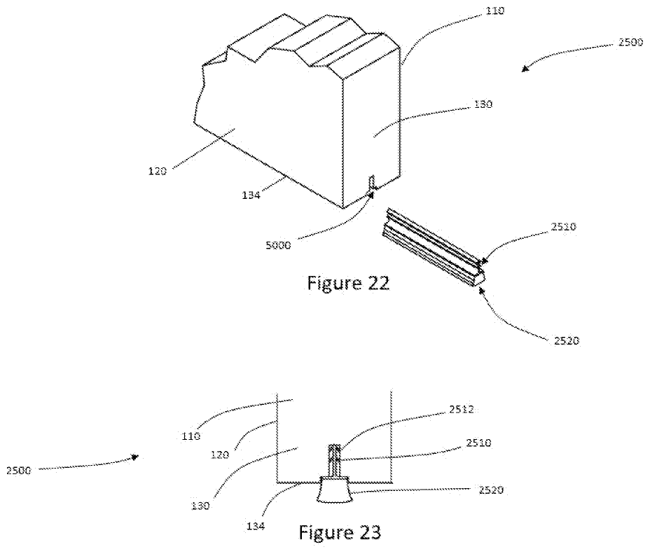

As shown in FIGS. 19-23, the airflow restricting assemblies 2500 each comprise a rigid insert 2510, preferably composed of plastic, metal or the like. The rigid insert may be configured to be receivable within recesses disposed around the peripheral minor faces or alternatively the peripheral faces of the door member. The recesses are optionally detachable from the minor faces of the door member. The rigid insert may also be configured to complement the shape of the recess. Furthermore, the rigid insert may be configured to comprise a restrictor arrangement, the restrictor arrangement may also be adjustable in thickness.

The restrictor arrangements are configured to extend into the gap between the minor faces of the door member and the doorway aperture and/or door jamb, to thereby prevent or restrict airflow through that gap.

Associated with each insert is a preferably flexible restrictor arrangement 2520.

The restrictor arrangement 2520 may be integrally formed with, or glued to the rigid insert 2510.

The insert 2510 of each of the airflow restricting assemblies 2500 is receivable within recesses 5000 arranged around the periphery (minor faces) of the door member 110 as shown in FIGS. 4a, 4b, 4c and 4d, the shape of the recesses 5000 preferably being configured to complement the shape of the insert 2510, and vice versa. FIG. 4e shows a top view of a door member without airflow restricting assembly detail. FIG. 4f shows a front view of the same door member. FIG. 4g shows a side view of the door member without airflow restricting assemblies. FIG. 4h shows a top perspective view of the same door member.

It is envisaged that the inserts 2510 could be provided with barb formations 2512 that allow the inserts 2510 to be inserted into the recesses, and prevent the inserts 2510 from being easily removed from the recesses. However, inserts should always be removable (for painting) or replaceable (if worn or damaged). Alternately, the inserts 2510 could be bonded in place in the recesses for certain applications.

The restrictor arrangements 2520 could be composed of a flexible rubber, silicon or other similar plastic. Alternatively, the restrictor arrangements 2520 could be composed of many small flexible fibres.

In operation, once the inserts 2510 are received into the recesses 5000, the restrictor arrangements 2520 are configured to extend into the gap between the minor faces 130 of the door member 110 and the doorway aperture or door jamb 4000 (not shown), to thereby prevent or restrict airflow through that gap.

In an alternate embodiment, the airflow restricting assemblies 2500 may be receivable within recesses 5000 arranged around the inner peripheral faces of the door jamb 4000 as shown in FIGS. 19-21. It is envisaged that a recess 5000 and airflow restricting assembly 2500 will be provided on an inner peripheral face of the doorway aperture or door jamb 4000 at a point closest to the minor faces 130 of the door member 110 and the axis of the pivoting arrangement 2300, preferably with the restrictor arrangement 2520 making contact with the curved elongate minor face 131 of the door member 110. As the door member 110 is moved between its open positions on either side of the doorway aperture and closed position, the restrictor arrangement 2520 will remain in contact with the curved minor face 131, thereby restricting movement of air between the doorway aperture or door jamb and the curved elongate minor face 131 of the door member 110.

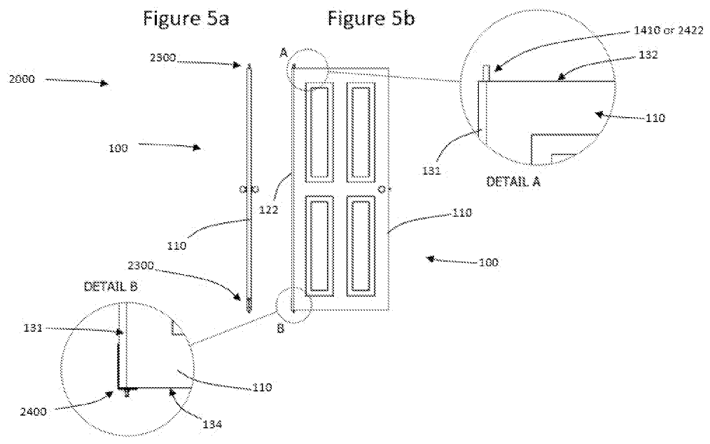

As shown in FIGS. 6 and 8, a series of parallel recesses 5000 may be provided on the pivoting arrangement 2300 side of the inner peripheral face of the doorway aperture or door jamb 4000, and airflow restricting assemblies 2500 provided for each of the parallel recesses, in order to increase the effect of the airflow restricting assemblies 2500. A series of parallel recesses 5000 may also be provided on the latching arrangement 2100 side of the door member 110 to receive additional airflow restricting assemblies 2500 to increase the effect of restricting airflow, as shown in FIG. 6, detail B.

### Interpretation

### Door

Any reference to the term “door” in this specification is defined to include a reference to a window, and the terms “doors” and “doorway” is to be construed accordingly.

### Markush Groups

In addition, where features or aspects of the invention are described in terms of Markush groups, those skilled in the art will recognise that the invention is also thereby described in terms of any individual member or subgroup of members of the Markush group.

### Chronological Sequence

For the purpose of this specification, where method steps are described in sequence, the sequence does not necessarily mean that the steps are to be carried out in chronological order in that sequence, unless there is no other logical manner of interpreting the sequence.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the construction and door industries.

The claims defining the invention are as follows:

1. A door for closing a doorway aperture defining at least one or more peripheral faces in a dual opening fashion, the door comprising:
a. a door member defining a pair of major faces and at least one or more minor faces at a peripheral edge of the major faces;
b. an airflow restricting assembly including a rigid insert and a restrictor arrangement associated with the rigid insert, wherein the airflow restricting assembly is configured to allow for adjustability of a thickness of the restrictor arrangement; and
c. the door member being configured for connection to at least one or more pivoting arrangements in operation to thereby move between:
i. a closed position in which the door member is substantially aligned with the doorway aperture; and
ii. an open position in which the door member is pivoted from alignment with the doorway aperture to either side of the doorway aperture;
wherein, a cross-section of at least one of the minor faces of the door member is configured so that when the door is moved between an open and a closed position, and vice versa, the minor face remains proximate to at least one peripheral face of the doorway aperture.

2. The door of claim 1, wherein the door comprises at least one or more pivoting arrangements on which the door member is pivotable between its open position on either side of the doorway aperture and its closed position.

3. The door of claim 1, wherein the minor face of the door member is configured to remain at substantially the same distance relative to the peripheral face of the doorway aperture when the door member moves between its open position and its closed position.

4. A two-way door closing arrangement for closing a door located in a doorway aperture, the door being pivotably movable on a pivoting arrangement between a closed position in which the door is substantially in alignment with the doorway aperture, and an open position in which the door is movable out of alignment with the doorway aperture to either side of the doorway aperture, the door closing arrangement comprising:
a. a door engaging arrangement configured to be connectable to a door and configured to pivot with the door;
b. a doorway aperture engaging arrangement configured to be rigidly coupled to the doorway aperture;
c. a biasing arrangement configured for biasing movement of the door engaging arrangement relative to the doorway aperture engaging arrangement in operation to thereby bias movement of the door from an open position on either side of the doorway aperture to its closed position; and
d. wherein the biasing arrangement comprises
i. a door engaging arrangement;
ii. a doorway aperture engaging arrangement;
iii. at least one biasing member extending between the door engaging arrangement and the doorway aperture engaging arrangement; and
iv. wherein the at least one biasing member is configured to be torsioned in use when the door is moved from its closed condition to its open condition.

5. The two-way door closing arrangement of claim 4, wherein the biasing arrangement includes an adjusting arrangement which is configured to allow for adjustability of an amount of torsion that is applied to the at least one biasing member in use by varying the effective length of the at least one biasing member.

6. The two-way door closing arrangement of claim 5, wherein the adjusting arrangement includes a manually manipulable member that is adjustable using a locating pin.

7. The two-way door closing arrangement of claim 4, wherein the two-way door closing arrangement is further configured to act as a pivoting arrangement on which a door is pivotable about a pivoting axis.

8. The two-way door closing arrangement of claim 4, wherein the biasing arrangement comprises a receiving member.

9. The two-way door closing arrangement of claim 8, wherein the receiving member is configured for receiving at least part of the biasing member.

10. The two-way door closing arrangement of claim 4, wherein the door engaging arrangement and doorway aperture engaging arrangement are pivotable relative to each other on an axis coaxial with the pivoting arrangement.

11. The two-way door closing arrangement of claim 4, wherein the doorway aperture engaging arrangement is configured for fixedly engaging with the biasing arrangement.

12. The two-way door closing arrangement of claim 4, wherein the doorway aperture engaging arrangement defines a complementary receiving formation configured for receiving a locating formation on the receiving member.

13. The two-way door closing arrangement of claim 12, wherein the locating formation is a complementary spline formation.

14. The two-way door closing arrangement of claim 4, wherein the door engaging arrangement comprises a cylindrical housing.

15. The two-way door closing arrangement of claim 14, wherein the cylindrical housing is configured for snug engagement in one or more selected from a recess or bore in a door member or from a peripheral face of the doorway aperture.

16. A door assembly for restricting access through a doorway aperture, the door assembly comprising
a. door for closing a doorway aperture defining at least one or more peripheral faces in a dual opening fashion, the door comprising:
i. a door member defining a pair of major faces and at least one or more minor faces at a peripheral edge of the major faces;
ii. an airflow restricting assembly including a rigid insert and a restrictor arrangement associated with the rigid insert, wherein the airflow restricting assembly is configured to allow for adjustability of a thickness of the restrictor arrangement; and
iii. the door member being configured for connection to at least one or more pivoting arrangements in operation to thereby move between:
1. a closed position in which the door member is substantially aligned with the doorway aperture; and
2. an open position in which the door member is pivoted from alignment with the doorway aperture to either side of the doorway aperture;
wherein, a cross-section of at least one of the minor faces of the door member is configured so that when the door is moved between an open and a closed position, and vice versa, the minor face remains proximate to at least one peripheral face of the doorway aperture, the door being configured for being received within a doorway aperture; and
b. the two-way door closing arrangement of claim 4.

17. A two-way door assembly for restricting access through a doorway aperture, the door assembly comprising:
a. a door member defining a pair of major faces and at least one or more minor faces at a peripheral edge of the major faces, wherein the cross-section of at least one of the minor faces of the door member is configured to be substantially curved, so that in operation when the door is moved between its open position on either side of the doorway aperture and its closed position, the curved minor face remains proximate to at least one peripheral face of the doorway aperture;
b. a pivoting arrangement configured for facilitating pivotal movement of the door member about a pivot axis, the pivot axis extending through the door member proximate to the pivoting side; and
c. an airflow restricting assembly including a rigid insert and a restrictor arrangement associated with the rigid insert, wherein the airflow restricting assembly is configured to allow for adjustability of a thickness of the restrictor arrangement.

18. A door assembly for restricting access through a doorway aperture, the door assembly comprising:
a. a door member defining a pair of major faces and at least one or more minor faces at a peripheral edge of the major faces, wherein the cross-section of at least one of the minor faces of the door member is configured to be substantially curved, so that in operation when the door is moved between its open position from either side of the doorway aperture and the closed position, the curved minor face remains proximate to at least one peripheral face of the doorway aperture;
b. a hinge arrangement;
c. a door member defining a pair of major faces, the major faces defining at least one straight pivoting side at which at least one curved elongate minor face extends between the major faces;
d. a hinge arrangement configured for facilitating pivotal movement of the door member about a pivot axis, the pivot axis extending through the door member proximate to the pivoting side; and
e. an airflow restricting assembly including a rigid insert and a restrictor arrangement associated with the rigid insert, wherein the airflow restricting assembly is configured to allow for adjustability of a thickness of the restrictor arrangement.

19. The door assembly as claimed in any one of claim 17, wherein the minor face is curved in a substantially semicircular shape in cross-section.

20. The door assembly as claimed in any one of claim 17, wherein the pivot axis of the hinge arrangement is substantially coaxial with the centre of the semicircular shape of the minor face.
